(19) United States
(12) Patent Application Publication
(10) Pub. No.: US 2005/0124525 A1
(43) Pub. Date: Jun. 9, 2005

(54) Anionic viscoelastic surfactant

(75) Inventors: Robert Seth Hartshorne, Newmarket (GB); Trevor Lloyd Hughes, Cambridge (GB); Timothy Gareth John Jones, Cottenham (GB); Gary John Tustin, Sawston (GB)

Correspondence Address: SCHLUMBERGER-DOLL RESEARCH, 36 OLD QUARRY ROAD, RIDGEFIELD, CT, 06877-4108, US

(73) Assignee: SCHLUMBERGER TECHNOLOGY CORPORATION, Ridgefield, CT (US)

(21) Appl. No.: 10/993,985

(22) Filed: Nov. 19, 2004

(30) Foreign Application Priority Data
Nov. 29, 2003 (GB) GB 0327795.1

(51) Int. Cl. C11D 17/00

(52) U.S. Cl. 510/424

(57) ABSTRACT

An anionic viscoelastic surfactant with sulphonate head group of formula R—X—(CR₅CR₆)ₘ—SO₃⁻, in which groups R, X, R₅, R₆ and m are as defined, particularly for use as a wellbore service fluid.

### FIELD OF THE INVENTION

The present invention relates specifically to anionic viscoelastic surfactants with a sulphonate head-group and to viscoelastic wellbore treatment fluids comprising such surfactants.

### BACKGROUND OF THE INVENTION

In the recovery of hydrocarbons, such as oil and gas, from natural hydrocarbon reservoirs, extensive use is made of wellbore treatment fluids such as drilling fluids, completion fluids, work over fluids, packer fluids, fracturing fluids, conformance or permeability control fluids and the like.

In many cases significant components of wellbore fluids are thickening agents, usually based on polymers or viscoelastic surfactants, which serve to control the viscosity of the fluids. Typical viscoelastic surfactants are N-erucyl-N,N-bis(2-hydroxyethyl)-N-methyl ammonium chloride and potassium oleate, solutions of which form gels when mixed with inorganic salts such as potassium chloride and/or with organic salts such as sodium salicylate.

Conventional surfactant molecules are characterized by having one long hydrocarbon chain per surfactant head-group. In the viscoelastic gelled state these molecules aggregate into worm-like micelles. Gel breakdown occurs rapidly when the fluid contacts hydrocarbons, which cause the micelles to change structure or disband.

In practical terms the surfactants act as reversible thickening agents so that, on placement in subterranean reservoir formations, the viscosity of a wellbore fluid containing such a surfactant varies significantly between water- or hydrocarbon-bearing zones of the formations. In this way the fluid is able preferentially to penetrate hydrocarbon-bearing zones.

The application of viscoelastic surfactants in both non-foamed and foamed fluids used for fracturing subterranean formations has been described in several patents, e.g. EP-A-0835983, U.S. Pat. No. 5,258,137, U.S. Pat. No. 5,551,516, U.S. Pat. No. 5,964,295 and U.S. Pat. No. 5,979,557.

The use of viscoelastic surfactants for water shut off treatments and for selective acidizing is discussed in GB-A-2332224 and Chang F. F., Love T., Affeld C. J., Blevins J. B., Thomas R. L. and Fu D. K., “Case study of a novel acid diversion technique in carbonate reservoirs”, Society of Petroleum Engineers, 56529, (1999).

The ideal composition for such wellbore treatment fluids has been the subject of much experimentation over the years, with the precise composition varying depending partly on the conditions in which the fluid will be used. In the formation of cleavable and high temperature viscoelastic surfactants that can be used to formulate aqueous viscoelastic fluids broadly applicable as wellbore service fluids and, in particular as hydraulic fracturing fluids, the prior art has shown that inclusion of an anionic carboxylate, COO⁻, or sulphonate, SO₃⁻ group within the structure of a surfactant can be beneficial.

Such structures are typified by formula 2 of WO 02/064945:
R₁—X—(CR₅R₆)ₘ-A⁻B⁺
in which R₁ is a saturated or unsaturated, linear or branched aliphatic chain of at least 18 carbon atoms, X is an O(CO), (CO)O, R₇N(CO) or (CO)NR₇ group, m is at least 1, R₇ is hydrogen or a linear or branched saturated aliphatic chain of at least 1 carbon atom or a linear or branched saturated aliphatic chain or at least 1 carbon atom with one or more of the hydrogen atoms replaced by a hydroxyl group, A⁻ is a sulphonate or carboxylate anionic group and B⁺ is an ionic counterion.

Further examples of such structures are provided by WO 02/064947, which describes an aqueous viscoelastic fluid comprising a surfactant of formula R—X—Y-Z in which R is the hydrophobic tail of the surfactant, Z is the hydrophilic head of the surfactant, for example COO⁻, X is a stabilising group and Y is a linear, saturated or unsaturated chain of 1, 2 or 3 carbon atoms, possibly incorporating an aromatic ring.

Patent application WO 02/11874 (GB 0103131) also describes viscoelastic wellbore treatment fluids based on a monomer subunit of structure (R₁—X)ₚZₘ in which X is a charged head group such as carboxylate, sulphate, sulphonate, phosphate, or phosphonate, R₁ is a C₁₀-C₅₀ organic tail, Z is a counterion and p and m are integers that ensure the subunit has a neutral charge.

Further examples of surfactants including a carboxylate or sulphonate group are provided by US Published Patent Application No. 2003/0073585 and U.S. Pat. No. 6,491,099 which describe a fluid comprising (a) an aqueous base, (b) a surfactant of formula R₁—CO—NR₂—CH₂—X where R₁ is a fatty acid chain having from 12 to 24 carbon atoms, R₂ is hydrogen, methyl, ethyl, propyl or butyl and X is carboxyl or sulphonyl and (c) a buffer for adjusting the pH of the combined aqueous base and surfactant above 6.5.

U.S. Published patent application Ser. No. 2002/0189810 also claims a fracturing fluid comprising a liquid carrier, a viscoelastic anionic surfactant and an amphoteric polymer. The anionic surfactant is of the same formula as that described in U.S. Published patent application Ser. No. 2003/0073585 and the pH of the fluid is adjusted to be “at least 4.5 and preferentially above 7.0”.

The use of alkyl amido quaternary ammonium salts as thickening agents in aqueous based fluids applicable as hydraulic fracturing fluids, completion fluids and well drilling fluids is described in WO 01/18147. Herein described is a family of cationic gelling agents of structure R₁—N⁺—(R₂)(R₃)—R₄ in which R₁ is an alkyl amido alkylene group, R₂ and R₃ are alkyl groups and R₄ is an alkyl sulphonate group. All compounds covered by this application incorporate a positively charged nitrogen atom within a quaternary ammonium group.

The use of amide sulphonates in oilfield applications is also known. For example, N-acyl N-methyl taurates have been used as foaming agents in foam drilling and workover applications (U.S. Pat. No. 3,995,705) and as scale inhibitors in acidising formulations (U.S. Pat. No. 3,924,685, U.S. Pat. No. 3,921718 and U.S. Pat. No. 3,921,716). Of these, for example, U.S. Pat. No. 3,924,685 describes a method of increasing and sustaining production of fluids from a subterranean fluid-bearing formation by injecting an aqueous solution containing a water-soluble substituted taurine, such as N-oleoyl N-methyl taurate, sodium N-palmitoyl N-methyl taurate or sodium N-acyl N-methyl taurate. This patent does not, however, (i) demonstrate that such water-soluble substituted taurine compounds can form viscoelastic gels or (ii) describe any methods to cause an increase in the viscosity of the fluid.

Until now, therefore, as may be seen from the above review of the art, viscoelastic surfactants have generally been described in which the charged hydrophilic head-group of the structure can be any one of carboxylate, sulphate, sulphonate, phosphate or phosphonate. Amide sulphonates have found use as surfactants in a variety of oilfield applications, but have not been used in the preparation of viscoelastic surfactant gels.

Definitions

The terms “carbo”, “carbyl”, “hydrocarbo” and “hydrocarbyl”, when used herein, pertain to compounds and/or groups which have only carbon and hydrogen atoms.

The term “saturated” when used herein, pertains to compounds and/or groups which do not have any carbon-carbon double bonds or carbon-carbon triple bonds.

The term “unsaturated” when used herein, pertains to compounds and/or groups which have at least one carbon-carbon double bond or carbon-carbon triple bond.

The term “aliphatic”, when used herein, pertains to compounds and/or groups which are linear or branched, but not cyclic (also known as “acyclic or “open-chain” groups).

By an “oligomeric” or “oligomer” surfactant we mean that the structure of the surfactant is based on from two to eight (and preferably two to five) linked surfactant monomer units. The monomer units are linked in the oligomer either head group-to-head group or tail group-to-tail group. When they are linked head group-to-head group, the oligomer has distinct tail groups corresponding to the tail groups of the monomer units and a super-head group formed from the plural head groups of the monomer units. When they are linked tail group-to-tail group, the oligomer has distinct head groups corresponding to the head groups of the monomer units and a super-tail group formed from the plural tail groups of the monomer units.

Although the oligomer is defined above in relation to a chemically-corresponding monomer unit, in practice the oligomer surfactant may not necessarily be synthesised from that monomer. For example, a synthesis route may be adopted in which monomer units are first oligomerised and the head groups are then changed to those of the desired oligomer surfactant. That is the head groups of the monomer units used in practice to form the oligomer may be different from the head groups of the monomer units to which the oligomer chemically corresponds. In another example, if the tail groups of the monomers actually used to form the oligomer are unsaturated, the oligomerisation process may involve the partial or total hydrogenation of those groups, particularly if the tail groups are linked in the oligomer.

Furthermore the tail groups of the monomer units actually used to form the oligomer may be aliphatic, but if the monomer units are linked in the oligomer tail group-to-tail group, the links formed between the tail groups in the super-tail group may be aliphatic, alicyclic or aromatic.

By a “viscoelastic” fluid we mean that the elastic (or storage) modulus G′ of the fluid is equal to or greater than the loss modulus G″ as measured using an oscillatory shear rheometer (such as a Bohlin CVO 50) at a frequency of 1 Hz. The measurement of these moduli is described in An Introduction to Rheology, by H. A. Barnes, J. F. Hutton, and K. Walters, Elsevier, Amsterdam (1997).

By “straight chain” we mean a chain of consecutively linked atoms, all of which or the majority of which are carbon atoms. Side chains may branch from the straight chain, but the number of atoms in the straight chain does not include the number of atoms in any such side chains.

### SUMMARY OF THE INVENTION

Having recognised and demonstrated various previously unforeseen advantages, the present invention provides an anionic viscoelastic surfactant of formula I:
R—X—(CR₅R₆)ₘ—SO₃⁻
in which:
R is a saturated or unsaturated, linear or branched aliphatic hydrocarbon chain comprising from 6 to 22 carbon atoms, including mixtures thereof and/or optionally incorporating an aryl group;
X is —(C═O)N(R₇)—, —N(R₇)(C═O)—, —N(R₇)—, —(C═O)O—, —O(C═O)— or —O(CH₂CH₂O)ₚ— where p is 0 or an integer of from 1 to 5;
R₅ and R₆ are each independently hydrogen or a linear or branched saturated aliphatic hydrocarbon chain of at least 1 carbon atom or a linear or branched saturated aliphatic hydrocarbon chain of at least 1 carbon atom with one or more of the hydrogen atoms replaced by a hydroxyl group; or when X is —N(R₇)(C═O)— or —O(C═O)—, the group (CR₅R₆) may include a COO⁻ group;
R₇ may be hydrogen, a linear saturated aliphatic hydrocarbon chain of at least 1 carbon atom, a branched saturated aliphatic hydrocarbon chain of at least-2 carbon atoms, a linear saturated aliphatic hydrocarbon chain of at least 1 carbon atom or a branched saturated aliphatic hydrocarbon chain or at least 2 carbon atoms with one or more of the hydrogen atoms replaced by a hydroxyl group, or a cyclic hydrocarbon group; and
m is an integer of from 1 to 4;
in the form of a monomeric unit, dimer or oligomer.

In a further aspect, the present invention also provides the use of a viscoelastic surfactant of formula I as hereinabove defined, as a wellbore treatment fluid.

In a yet further aspect, the present invention provides a method for the preparation of a viscoelastic surfactant of formula I as hereinabove defined.

The present inventors have now surprisingly discovered that several previously unknown important benefits are associated with the use of sulphonate as the charged hydrophilic head group in a viscoelastic surfactant specifically having formula I as herein above defined. These important benefits include:
1. Sulphonate surfactants are soluble in and can form viscoelastic gels in aqueous solutions adjusted to or buffered at a wide range of pH conditions. For example, viscoelastic gels based on sulphonate surfactants can be formulated under pH conditions ranging from strongly acidic through neutral to strongly alkaline conditions. This leads to their potential application in matrix acidising and associated diversion systems, acid fracturing and neutral/alkaline fracturing fluids. Further, we note that the properties of viscoelastic gels based on sulphonate surfactants may depend on pH which leads to the potential for designing gels which subsequently de-gel on changing the prevailing pH condition. This effect introduces an additional feature which may be used in delayed gelation systems or in systems designed to de-gel for improved clean-up. It is noted here that acidic, neutral or alkaline gels based on viscoelastic sulphonate surfactants are easily broken down by interaction with hydrocarbons.
2. Many sulphonate surfactants are well known to be good foamers [Porter, M. R., “Handbook of Surfactants”, 2^{nd} Edition, Blackie Academic & Professional, Chapman & Hall, 1994) and they have found particular application in forming stable foams with CO₂ as the internal gas or supercritical fluid phase [Heller, J. P. Chapter 5 in “Foams: Fundamentals and Applications in the Petroleum Industry” edited by Schramm, L L. Am Chem Soc Advances in Chemistry Series, 242, 1994 and Borchardt et al., Society Petroleum Engineers (SPE) paper 14394 presented at the 60^{th} Annual Technical Conference, Sep. 22-25, 1985]. Again, this is related to the compatibility of sulphonate surfactants with acid conditions, in this case generated when the external aqueous phase of the foam is equilibrated with a significant partial pressure of CO₂ [Chambers, Chapter 9 in “Foams: Fundamentals and Applications in the Petroleum Industry” edited by Schramm, L L. Am Chem Soc Advances in Chemistry Series, 242, 1994]. As discussed in the next section, amide sulphonate surfactants and, in particular, di-substituted taurates have already found oilfield application in foam drilling [U.S. Pat. No. 3,995,705] and in acidising fluids with improved scale inhibition properties [U.S. Pat. No. 3,924,685, U.S. Pat. No. 3,921,718 and U.S. Pat. No. 3,921,716]. The potential for viscoelastic surfactants which are both chemically compatible with CO₂ and which can produce stable CO₂ foams provides an opportunity for highly cost-effective foamed fracturing fluids based on CO₂ co-injected with an aqueous viscoelastic surfactant gel phase. Such technology has important application in certain key markets.
3. It is well known that carboxylate surfactants are more sensitive to the presence of polyvalent cations than the corresponding phosphates, sulphates or sulphonates [Porter, M. R., “Handbook of Surfactants”, 2^{nd} Edition, Blackie Academic & Professional, Chapman & Hall, 1994]. Thus, sulphonate VES are compatible with a higher concentration of divalent cations (e.g. Ca⁺⁺, Mg⁺⁺) present in the mixwater used to prepare the fluid or in backflowing formation brine as compared to carboxylate VES. Therefore, when using fracturing fluids based on sulphonate VES there is a lesser need to add divalent cation chelating agents (e.g. EDTA) to the formulation; this has important operational advantages. Furthermore, when the sulphonate VES is an amide sulphonate such as N-oleyl or N-tallowyl N-methyl taurate, the VES component also inhibits scale formation (as per the discussion given in U.S. Pat. No. 3,924,685, U.S. Pat. No. 3,921,718 and U.S. Pat. No. 3,921,716).
4. In any application of a viscoelastic surfactant as a wellbore service fluid (e.g. as a fracturing fluid) it is an important operational advantage that the VES can be delivered to the flowstream in the form of an easily pumpable liquid containing a high concentration of active viscoelastic surfactant. In the case of sulphonate VES, this can be achieved by liquifying the active component in its neutral or salt form. For example, the VES N-oleyl N-methyl taurate can be delivered via a liquid concentrate containing a high concentration of its sodium or potassium salt. Depending on the application, this neutral concentrate can be metered into an acidic brine stream (acid fracturing) or neutral/alkaline brine stream (neutral/alkaline fracturing) in order to form the viscoelastic gel as required. Furthermore, a neutral viscoelastic gel can be delivered without the need for the addition of any acid or alkali.

### DESCRIPTION OF THE DRAWINGS

FIG. 1: demonstrates the ability of the surfactant N-oleyl N-methyl taurate to form viscous fluids in a wide range of pH conditions and the maintenance of viscosity at temperatures from room temperature up to the range 180-240° F. (82-115° C.)

FIG. 2: shows the full rheograms corresponding to the data illustrated in FIG. 1 for the fluid at pH 12. The fluids are viscoelastic gels and viscoelasticity is assessed by measurement of dynamic (oscillatory) rheology.

FIG. 3: shows, schematically, the effect of fluid pH on viscosity: it is possible to formulate a strongly acidic or strongly alkaline viscoelastic fluid which subsequently loses its viscosity as the fluid pH is neutralised either by increasing the pH or decreasing the pH using additives within the fluid or by interaction of the acidic or alkaline fluid with formation brine during backflow.

FIG. 4: illustrates the rheology of a viscoelastic gel based on N-oleyl N-methyl taurate. The surfactant product is Hostapon TPHC available from Clairant GmbH, Surfactant Division, Frankfurt, Germany.

FIG. 5: shows the viscoelastic gel formed by N-oleyl N-methyl taurate on addition of calcium chloride without any coaddition of a monovalent alkali metal salt such as sodium chloride or potassium chloride.

FIG. 6: illustrates that potassium chloride can be used in place of sodium chloride in the formation of a viscoelastic gel by N-oleyl N-methyl taurate.

FIG. 7: shows that Adinol OT64 powder can be liquefied using a mixture of isopropanol and water, the result being a low viscosity liquid with product activity 40 wt % (25.6 wt % N-oleyl N-methyl taurate).

FIG. 8: demonstrates that there is little or no apparent reduction in the low or high shear viscosity of the viscoelastic gel prepared using either the liquid product of the powdered product.

FIG. 9: shows that a stable foam is easily formed on vigorous shaking of an N-oleyl N-methyl taurate fluid at pH 3.5, thereby indicating that the foaming properties of the surfactant are maintained under low pH conditions such as those prevailing in a CO₂-foamed viscoelastic gel.

FIG. 10: shows that viscoelastic gels can be formulated using lower concentrations of N-oleyl N-methyl taurate and that the temperature tolerance of such gels decreases with decreasing surfactant concentration.

FIG. 11: shows the rheology of example formulations where the primary surfactant is N-oleyl N-methyl taurate in mixed surfactant systems containing a secondary surfactant. Mixed N-oleyl N-methyl taurate/potassium oleate gels can be formulated for use under alkaline conditions.

FIG. 12: shows that sodium N-oleyl N-methyl taurate can form a viscoelastic gel on addition of oleyl diethanolamide, in the absence of any added salt.

FIG. 13: shows the flow rheology of a gel formulation based on 6 wt % Tauranol (where the Tauranol product is a solution of 32-33 wt % sodium N-tallyl N-methyl taurate in an ispropanol/water mixture supplied by Finetex Inc., North Carolina, U.S.A.) and 6 wt % sodium chloride at pH 12 measured at 25, 40 and 60° C.

FIG. 14: shows the flow rheology of a gel formulation based on 6 wt % Tauranol (where the Tauranol product is a 28 wt % solution of a mixed potassium/sodium N-tallyl N-methyl taurate salt in water again supplied by Finetex Inc., North Carolina, U.S.A.) and 6 wt % sodium chloride at pH 12 measured at 25, 40 and 60° C.

### DETAILED DESCRIPTION OF THE INVENTION

The present invention provides, in its first aspect, an anionic viscoelastic surfactant of formula I:
R—X—(CR₅R₆)ₘSO₃
in which:
R is a saturated or unsaturated, linear or branched aliphatic hydrocarbon chain comprising from 6 to 22 carbon atoms, including mixtures thereof and/or optionally incorporating an aryl group;
X is —(C═O)N(R₇)—, —N(R₇)(C═O)—, —N(R₇)—, —(C═O)O—, —O(C═O)— or —O(CH₂CH₂O)ₚ— where p is 0 or an integer of from 1 to 5;
R₅ and R₆ are the same or different and are each independently hydrogen or a linear or branched saturated aliphatic hydrocarbon chain of at least 1 carbon atom or a linear or branched saturated aliphatic hydrocarbon chain of at least 1 carbon atom with one or more of the hydrogen atoms replaced by a hydroxyl group; or
when X is —N(R₇)(C═O)— or —O(C═O)—, the group (CR₅R₆) may include a COO⁻ group;
R₇ may be hydrogen, a linear saturated aliphatic hydrocarbon chain of at least 1 carbon atom, a branched saturated aliphatic hydrocarbon chain of at least 2 carbon atoms, a linear saturated aliphatic hydrocarbon chain of at least 1 carbon atom or a branched saturated aliphatic hydrocarbon chain of at least 2 carbon atoms with one or more of the hydrogen atoms replaced by a hydroxyl group, or a cyclic hydrocarbon group; and
m is an integer of from 1 to 4;
in the form of monomeric unit, a dimer or oligomer.

In the compound of formula I, R is a saturated or unsaturated, linear or branched aliphatic hydrocarbon chain comprising from 6 to 22 carbon atoms, including mixtures thereof and/or optionally incorporating an aryl group.

R can be a mixture of saturated and unsaturated hydrocarbon chains obtained from fatty acid(s) derived from a number of natural oils and fats including, for example, coconut oil, tallow oil, tall oil, soya bean or rapeseed oil.

Preferably R has a composition and/or degree of unsaturation which is sufficient to render the surfactant soluble in water at the typical surface temperatures prevailing in an oilfield wellsite environment. Thus, as defined by the iodine value (IV—which is a measure of the unsaturation of the fatty acids and is expressed in terms of the number of centigrams of iodine absorbed per gram of sample) of the fatty acid or fatty acid mixture, the range of unsaturation should be within the IV range of 1-200 and preferably within the IV range of 40-110.

Preferably, R is a fully or partially saturated, linear or branched hydrocarbon chain of at least 15 carbon atoms and preferably of from 16 to 22 carbon atoms. More preferably, R is derived from fatty acids such as palmitic acid, erucic acid, oleic acid, coconut oil acid, tallow acid, tall oil acid, soya oil acid or rapeseed oil acid. The physical appearance, iodine value, acid value and composition of oleic acid, tallow acid and tall oil acid are compared to the same properties of stearic acid in the table given

Typical Fatty Acid Compositions

| Fatty Acid | Stearic Acid | Tallow Acid | Oleic Acid | Tall Oil Fatty Acid |
|---|---|---|---|---|
| Physical appearance (25° C.) | Solid powder | High viscosity slurry | Low viscosity oil | Low viscosity oil |
| Iodine Value | 1 max | 50-55 | 105-125 | 131 |
| Acid Value | 202-209 | 203 | 194-210 | 194 |

Typical compositions

| | | | | |
|---|---|---|---|---|
| C15 & lower | 3 | 3 | 5 | |
| C16 = 1 | 31 | 25 | | |
| C18 | 65 | 17 | 2 | 5 |
| C18 = 1 | | 50 | 59 | 51 |
| C18 = 2 | | 5 | 23 | 35 |
| C18 = 3 | | | 11 | 9 |

below:

Notes: (i) The iodine value is a measure of the unsaturation of the fatty acid mixture and is expressed in terms of the number of centigrams of iodine absorbed per gram of sample, (ii) The acid value is a measure of the amount of alkali required to neutralise the fatty acid expressed in terms of the number of milligrams of potassium hydroxide required to neutralise 1 gram of the fatty acid, (iii) C18=1, C18=2 and C18=3 refer to a partially unsaturated hydrocarbon chain composed of 18 carbons atoms in which there is one, two or three double bonds, respectively, (iv) the “Typical compositions” data are quoted as weight percentages.

In the compound of formula I, R₅ and R₆ are the same or different and are each independently hydrogen, a linear saturated aliphatic hydrocarbon chain of at least 1 carbon atom, a branched saturated aliphatic hydrocarbon chain of at least 2 carbon atoms, a linear saturated aliphatic hydrocarbon chain of at least 1 carbon atom or a branched saturated aliphatic hydrocarbon chain of at least 2 carbon atoms with one or more of the hydrogen atoms replaced by a hydroxyl group; or, when X is —N(R₇)(C═O)— or —O(C═O)—, the group (CR₅R₆) may include a COO⁻ group. Preferably, in these compounds, R₅ and R₆ are the same and are each hydrogen or a linear C₁₆alkyl or branched C₂₋₆alkyl group, more preferably hydrogen or a methyl or ethyl group.

In the compounds of formula I, R₇ is hydrogen, a linear saturated aliphatic hydrocarbon chain of at least 1 carbon atom, a branched saturated aliphatic hydrocarbon chain of at least 2 carbon atoms, a linear saturated aliphatic hydrocarbon chain of at least 1 carbon atom or a branched saturated aliphatic hydrocarbon chain of at least 2 carbon atoms with one or more of the hydrogen atoms replaced by a hydroxyl group, or a cyclic hydrocarbon group. It is generally preferred that R₇ is hydrogen or a C₁₋₆ alkyl group or a C₁₋₆ alkyl group substituted with an aryl group. It is more preferred that R₇ is hydrogen, methyl, ethyl, propyl, butyl or an aryl substituted C₁₋₆alkyl group and most preferred that R₇ is hydrogen or methyl.

In the compound of formula I, m is an integer of from 1 to 4, preferably 2 or 3 and most preferably 2.

In one embodiment of the first aspect of the present invention, there is provided an anionic viscoelastic surfactant of formula II:
R—CO—NR₇—(CR₅CR₆)ₘSO₃⁻
i.e. a compound of formula I in which X is —(C═O)NR₇⁻,
in which: R, R₅, R₆, R₇ and m are as defined above; as a monomeric unit, a dimer or an oligomer.

It is preferred that, in this embodiment of this aspect of the invention, the anionic viscoelastic surfactant is of formula IIA:
R—CO—NR₇—CH₂CH₂—SO₃⁻
in which R is as defined above and the group R—CO— is preferably selected from N-cetyl, N-erucyl, N-oleoyl, N-cocoyl, N-tallowyl, N-tallyl, N-soyayl or N-rapeseedyl and most preferably is N-oleoyl; and
R₇ is as defined above and is preferably hydrogen or a C₁₋₆ alkyl group, more preferably hydrogen or methyl;
as a monomeric unit, a dimer or an oligomer.

In a further preferred embodiment of the first aspect of the present invention there is provided an anionic viscoelastic surfactant of formula III:
R—N(R₇)(CO)—(CR₅CR₆)ₘSO₃⁻
i.e. a compound of formula I in which X is —N(R₇)(C═O)—;
in which R, R₅, R₆, R₇ and m are as defined above;
as a monomeric unit, a dimer or an oligomer.

It is preferred that, when of formula III, the anionic viscoelastic surfactant is of formula IIIA:
R—N(R₇)(CO)—CH₂CH₂—SO₃⁻
in which R is as defined above and is preferably derived from fatty acids such as palmitic acid, erucic acid, oleic acid, coconut oil acid, tallow acid, tall oil acid, soya oil acid or rapeseed oil acid; and
R₇ is as defined above and is preferably hydrogen or a C₁₋₆ alkyl group, more preferably hydrogen or methyl;
as a monomeric unit, a dimer or an oligomer.

In another preferred embodiment of this aspect of the invention, there is provided an anionic viscoelastic surfactant of formula IV:
R—N(R₇)—(CR₅CR₆)ₘSO₃⁻
i.e. a compound of formula I in which X is —N(R₇)—,
in which R, R₅, R₆, R₇ and m are as defined above;
as a monomeric unit, a dimer or an oligomer.

It is preferred that R is derived from fatty acids such as palmitic acid, erucic acid, oleic acid, coconut oil acid, tallow acid, tall oil acid, soya oil acid or rapeseed oil acid; and
R₇ is as defined above and is preferably hydrogen or a C₁₋₆
alkyl group, more preferably hydrogen or methyl;
as a monomeric unit, a dimer or an oligomer.

In another preferred embodiment of this aspect of the invention, there is provided an anionic viscoelastic surfactant of formula V:
R—(C═O)O—(CR₅CR₆)ₘSO₃⁻
i.e. a compound of formula I in which X is —(C═O)O—;
in which R, R₅, R₆ and m are as defined above;
as a monomeric unit, a dimer or an oligomer.

It is preferred that, when of formula V, the anionic viscoelastic surfactant is of formula VA:
R—(C═O)O—CH₂CH₂—SO₃⁻
in which R is as defined above and is preferably derived from fatty acids such as palmitic acid, oleic acid, erucic acid, coconut oil acid, tallow acid, tall oil acid, soya oil acid or rapeseed oil acid.

Ester sulphonate surfactants of formula VA are generally known as “isethionate” surfactants as they may be produced by reacting the acid-chloride, R—(C═O)Cl with sodium isethionate, HOCH₂CH₂SO₃Na.

Again, compounds of formula V can include the monomeric, dimeric or oligomeric forms.

In another preferred embodiment of this aspect of the invention, there is provided an anionic viscoelastic surfactant of formula VI:
R—O(C═O)—(CR₅CR₆)ₘSO₃⁻
i.e. a compound of formula I in which X is —O(C═O)—;
in which R, R₅, R₆ and m are as defined above;
as a monomeric unit, a dimer or an oligomer.

It is preferred that, when of formula VI, the anionic viscoelastic surfactant is of formula VIA:
R—O(C═O)—CH₂CH₂—SO₃⁻
in which R is as defined above and is preferably derived from fatty acids such as palmitic acid, erucic acid, oleic acid, coconut oil acid, tallow acid, tall oil acid, soya oil acid or rapeseed oil acid;
as a monomeric unit, a dimer or an oligomer.

In another preferred embodiment of this aspect of the invention, there is provided an anionic viscoelastic surfactant of formula VII:
R—O(CH₂CH₂O)ₚ—(CR₅CR₆)ₘSO₃⁻
i.e. a compound of formula I in which X is —O(CH₂CH₂O)ₚ—;
in which R, R₅, R₆, m and p are as defined above;
as a monomeric unit, a dimer or an oligomer.

Most preferred anionic viscoelastic surfactants of the present invention are compounds of formula IIA, for example N-acyl N-methyl taurates, such as N-cetyl N-methyl taurate, N-erucyl N-methyl taurate, N-oleoyl N-methyl taurate, N-cocoyl N-methyl taurate, N-tallowyl N-methyl taurate, N-tallyl N-methyl taurate, N-soyayl N-methyl taurate and N-rapeseedyl N-methyl taurate or N-acyl taurates, such as N-erucyl taurate, N-oleoyl taurate, N-cocoyl taurate, N-tallowyl taurate, N-tallyl taurate, N-soyayl taurate and N-rapeseedyl taurate.

An oligomeric surfactant may be based on linked surfactant monomer units, each monomer unit having a formula as shown in any one of formulae I to VII above. The oligomeric surfactant may be formed as described in, for example, PCT Patent Publication No. WO 02/11874 or using techniques known in the art.

The following scheme illustrates the preparation of dimeric N-oley N-methyl taurate:

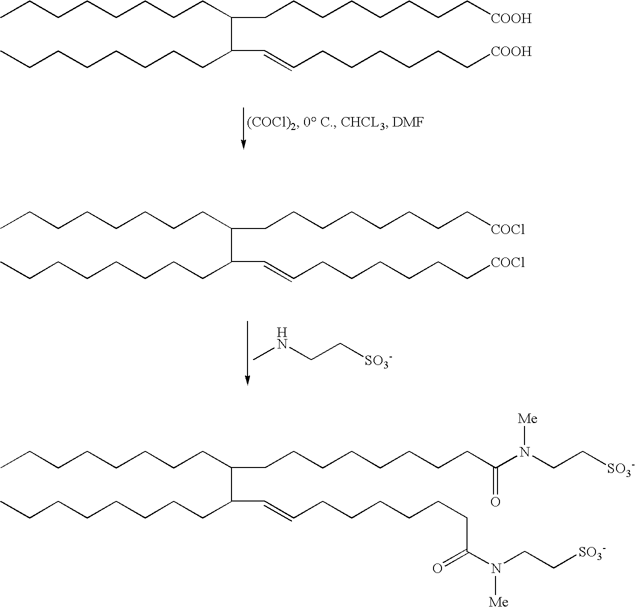

Thus, in respect of the surfactant of formula IIA, above, the acid chloride derivative of an oligomeric fatty acid may be used to prepare oligomeric surfactants of formula IIA, above and having the structure below:

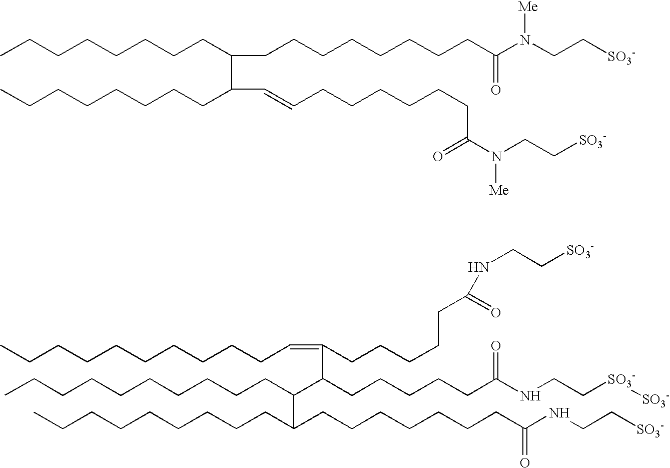

The first structure is di(N-oleyl N-methyl taurate) and the second structure is tri(N-oleyl taurate).

An acid chloride derivative of an fatty acid may be prepared using techniques common in the art, such as those described by Larock in “Comprehensive Organic Transformations: a guide to functional group preparations”, 2^{nd} Edition, Wiley-VCH, ISBN 0-471-19031-4 (1999).

Typical fatty acids that may be used in the manufacture of oligomeric forms of compounds of formula II or formula III via their corresponding amines include:

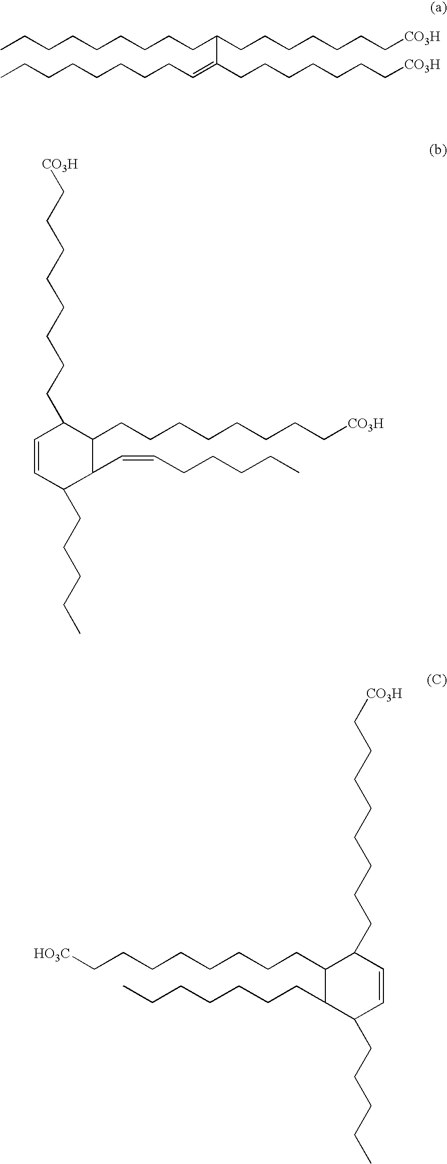

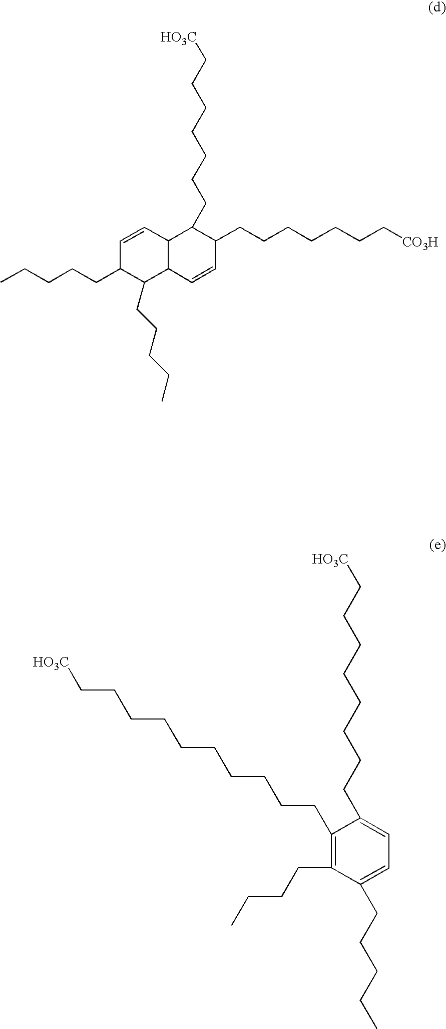

In the above formulae:
(a) is dimerised oleic acid.
(b) is 1,2-dinonanoic-3-hept-1-enyl-4-pentyl-cyclohex-5-ene
(c) is 1,2-dinonanoic-3-heptyl-4-pentyl-cyclohex-5-ene
(d) is 1,2-dinonanoic-5,6-dipentyl-bis-cyclohexa-3,7-diene.
(e) is 1,2-dinonanoic-5,6-dipentylbenzene.

Oligomeric amines can be obtained from a large range of oligomeric fatty acids including those shown above. The oligomeric acid can be converted to its equivalent oligomeric amine via the corresponding oligomeric amide, alcohol or nitrile. The oligomeric amine can then be reacted with the sulpho-carboxylic acid as shown in the exemplary synthetic steps for the preparation of compounds of formula III, shown below.

The anionic viscoelastic surfactants of the above formulae may be prepared by methods known in the art.

For the preparation of compounds of formula II, the following synthetic route may be followed:
RCOCl+R₇NHC(R₅R₆)ₘSO₃Na+NaOH→RCON(R₇)(CR₅R₆)ₘSO₃Na+NaCl+H₂O
wherein R₇NHC(R₅R₆)ₘSO₃Na may be obtained as follows:
R₇NH₂+HO(CR₅R₆)ₘSO₃Na→R₇NHC(R₅R₆)ₘSO₃Na+NaCl+H₂O
in which R, R₅, R₆, R₇ and m are as defined above.

The sodium chloride by product may optionally be removed, for example-by reverse osmosis (JP 04149169).

For the preparation of compounds of formula III, the following synthetic route may be taken as exemplary: 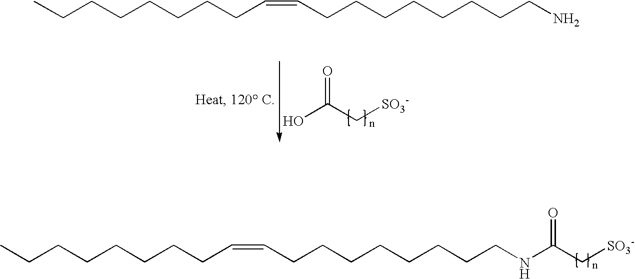
in which n has the same value as m, defined above.

For the preparation of compounds of formula IV, the corresponding amide sulphonate of formula II or III may be reduced. An exemplary synthetic route to the compounds of formula IV is provided below:

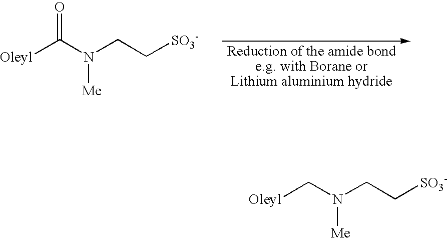

Alternatively, compounds of formula IV may be prepared by reaction of the monomeric or oligomeric amine R—NH₂ (wherein R is as previously defined) with compounds of formula OH—CH(R₅)—(CR₅R₆)ₘ—SO₃— (where R5 and R₆ are as defined above). U.S. Pat. No. 2,658,072 describes such a process of producing N-alkyl taurines having the formula RNHC(R′)H—CH₂SO₃X where R is an alkyl radical of from 8 to 18 carbon atoms, R′ is either hydrogen or methyl and X is either hydrogen, alkali metal, alkaline earth metal or ammonium. The examples in this reference detail process conditions for reacting N-tetradecylamine, N-octylamine, N-dodecylamine and “cocamine” with sodium isethionate; the patent includes data which show that the N-alkyl taurine products maintain good detergent and foaming properties in waters with hardness up to 300 p.p.m.

For the preparation of a compound of formula V, the following-method may be followed:
RCOCl+OH—CH(R₅)—(CR₅P₆)ₘ—SO₃Na→RCOO(CR₅R₆)ₘSO₃Na+HCl
in which m, R, R₅ and R₆ are as previously defined.

For the preparation of a compound of formula VI, the following method may be followed:

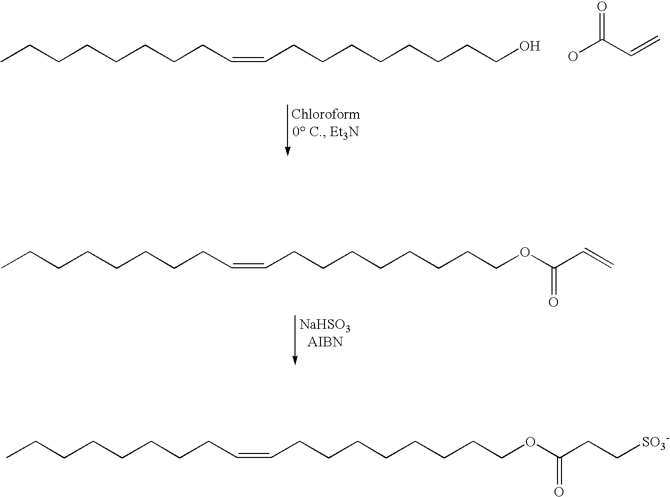

Compounds of formula VII can be prepared for example by the reaction of a fatty alcohol, epichlorohydrin and sodium sulphite; this reaction has been described in several patents such as U.S. Pat. No. 2,098,203 (assignee: Rohm and Hass) and U.S. Pat. Nos. 2,098,203, 2,106,716 and 2,115,192 (all three patents are assigned to the company Rohm and Hass). The reaction is shown below:
RO(CH₂CH₂O)pH+epichlorohydrin (ClC₃H₅O)+Na₂SO₃→RO(CH₂CH₂O)ₚCH₂—CH(OH)—CH₂SO₃⁻Na⁺

VES-based treatment fluids according to the present invention show wide applicability in wellbore applications. The fluids may be used as, for example, fracturing fluids, selective acidising fluids, water shut-off fluids, well clean-out fluids, diversion fluids for acid and scale dissolver. treatments. VES-based treatment fluids of the present invention are particularly useful as fracturing fluids.

VES-based treatment fluids of the present invention may be prepared by mixing the appropriate viscoelastic surfactant or mixture of viscoelastic surfactants with an aqueous solution (in practice, the mixwater that is available at the rigsite) with or without the addition of salt as determined by the composition of the available mixwater. The appropriate viscoelsatic surfactant will normally be added in the form of a concentrated liquid with high surfactant activity; such surfactant concentrates are normally composed of the surfactant liquefied in an appropriate alcohol with/without water. In some embodiments, the VES-based treatment fluid may also contain other additives such as the proppant added to VES-based fracturing fluids.

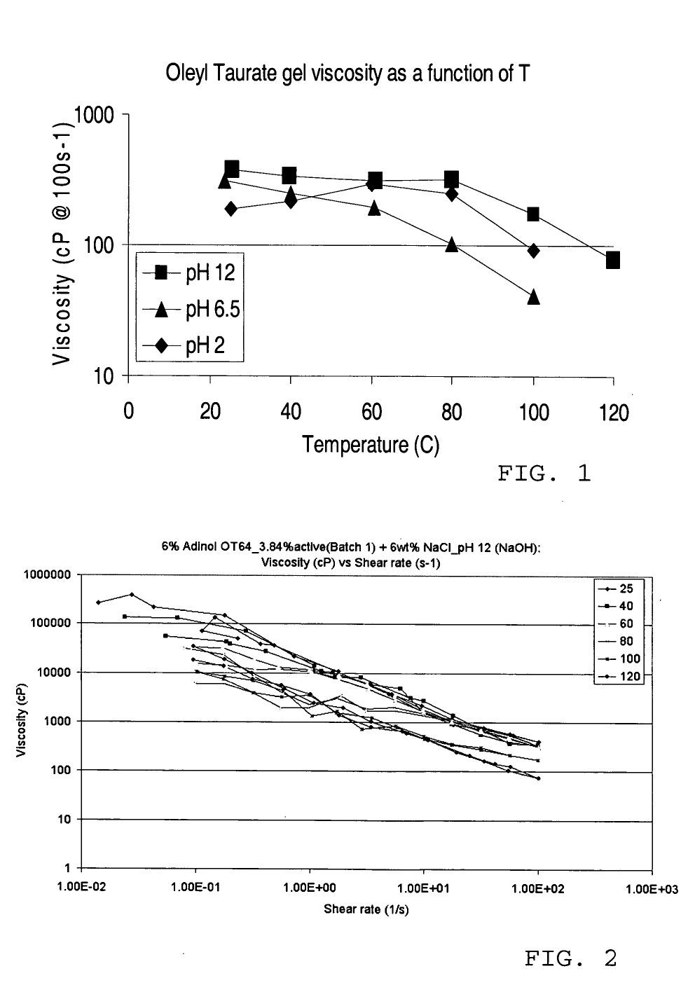

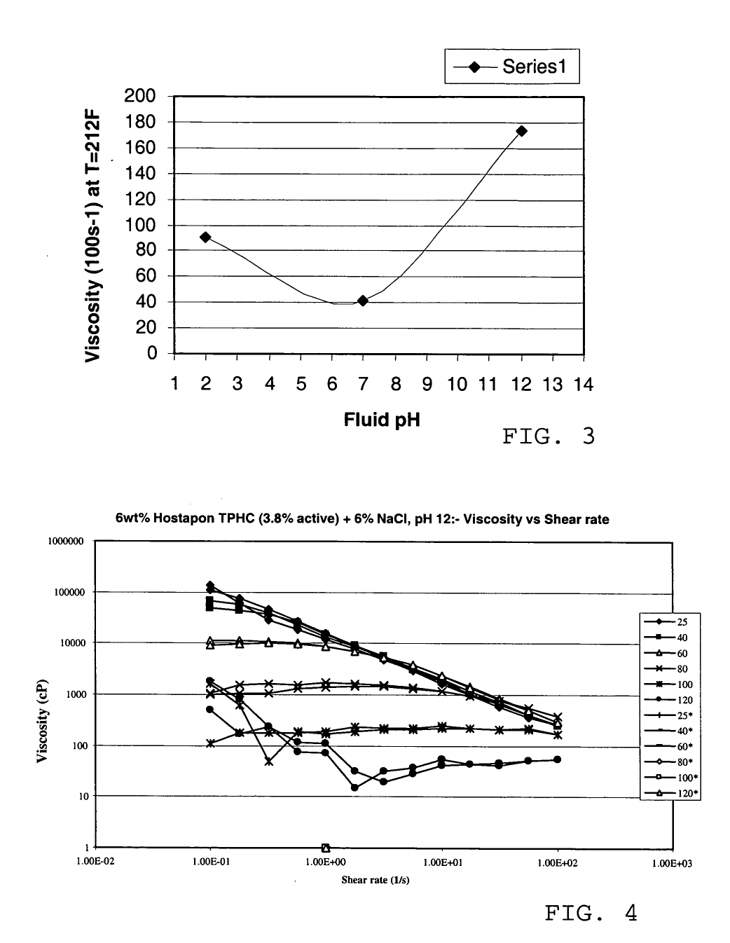

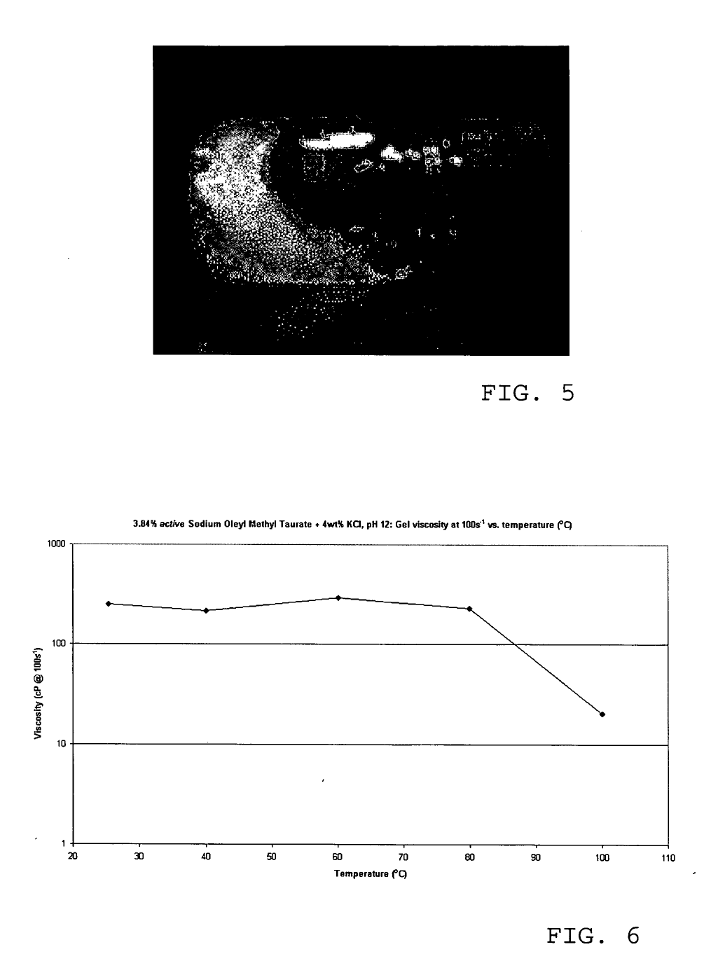

As discussed above, the surfactants of the present invention show advantages over the surfactants known from the prior art. Various of these advantages are demonstrated in the accompanying figures. Thus, FIG. 1 demonstrates that the surfactant N-oleyl N-methyl taurate can form viscous fluids in a wide range of pH conditions, from strongly acid to strongly alkaline conditions and that these fluids maintain their high viscosity (>100 cP at 100 s⁻¹) at temperatures from room temperature up to the range 180-240° F. In the case of the data presented in FIG. 1, the surfactant product is Adinol OT64 available from Croda Oleochemicals, Goole, England, the product being present at 6 wt % (equivalent to 3.84 wt % active N-oleyl N-methyl taurate) with 6 wt % sodium chloride added to all three fluids.

From FIG. 1, we observe that it is possible to formulate a strongly acidic or strongly alkaline viscoelastic fluid. The data illustrated in FIG. 3 show that the viscoelastic fluid tested in FIG. 1 subsequently loses its viscosity as the fluid pH is neutralized either by increasing the pH or decreasing the pH using additives within the fluid or by interaction of the acidic or alkaline fluid with formation brine during backflow.

A key advantage of using viscoelastic gels based on the sulphonate surfactants hereinabove described is their tolerance to the presence of divalent cations such as calcium ions. Typically, N-oleyl N-methyl taurate gels can tolerate at least 4000 mg/L Ca⁺⁺ (added as calcium chloride) compared to around 400 mg/L for gels based on oleyl amide succinate or <400 mg/L for gels based on oleic acid.

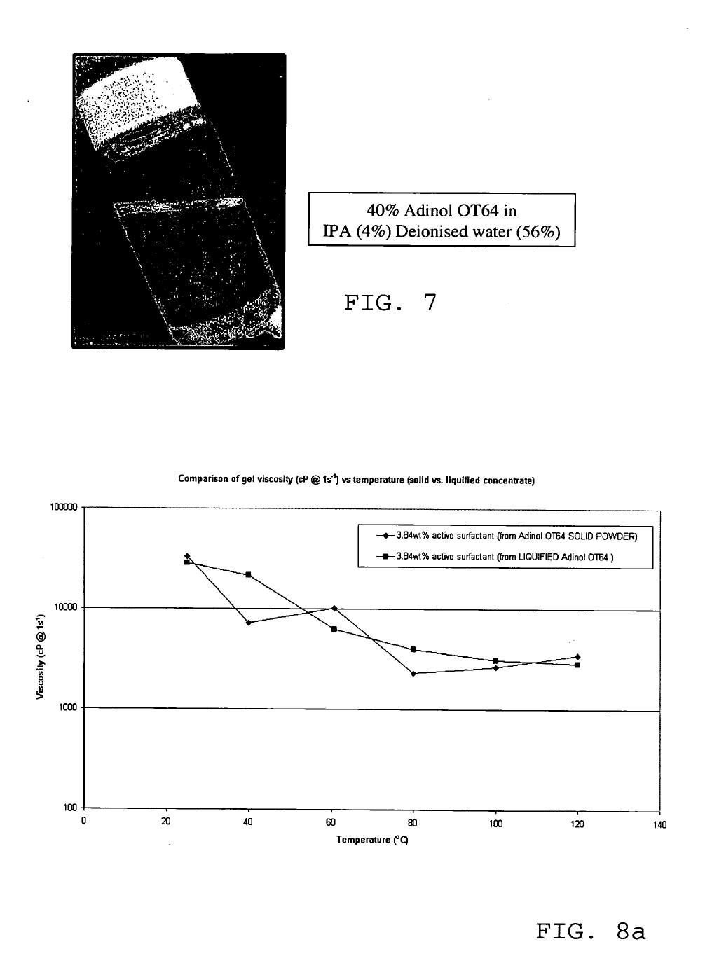

FIG. 5 shows the viscoelastic gel formed by N-oleyl N-methyl taurate on addition of calcium chloride without any coaddition of a monovalent alkali metal salt such as sodium chloride or potassium chloride. FIG. 6 shows that potassium chloride in place of sodium chloride can also be used to form the viscoelastic gel. This advantage allows viscoelastic gels based on the hereinabove described anionic sulphonate surfactants and especially N-oleyl N-methyl taurate, to show tolerance to broad variability in the ionic composition of the mixwater, including seawater.

Typically, N-oleyl N-methyl taurate products are high activity solid powders although liquid paste products are also available. FIG. 7 shows that the Adinol OT64 powder can be liquified using a mixture of isopropanol and water, the result being a low viscosity liquid with product activity 40 wt % (25.6 wt % N-oleyl N-methyl taurate). This particular solution does not represent the highest surfactant activity that can be achieved and other solvent chemistries and combinations can be employed such as other alcohols, glycol ethers and polyglycol ethers.

When the liquid product is used to prepare viscoelastic gels according to the invention there is little or no apparent reduction in the low or high shear viscosity of the gel compared to that achieved by preparing the same fluid using the powdered product (FIG. 8). An acidic, neutral or alkaline viscoelastic gel can be prepared from such a liquid concentrate of sodium N-oleyl N-methyl taurate.

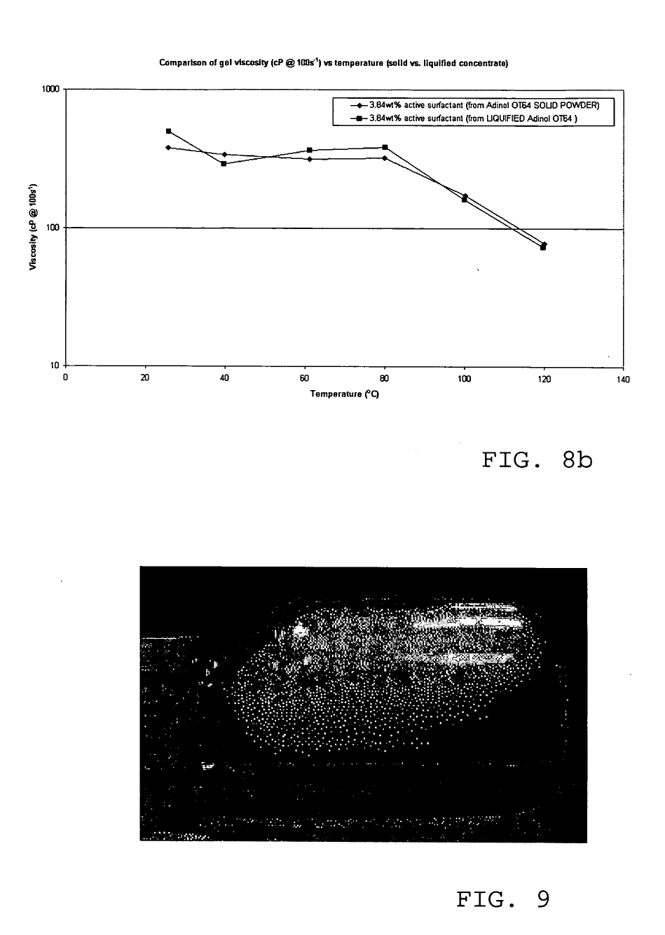

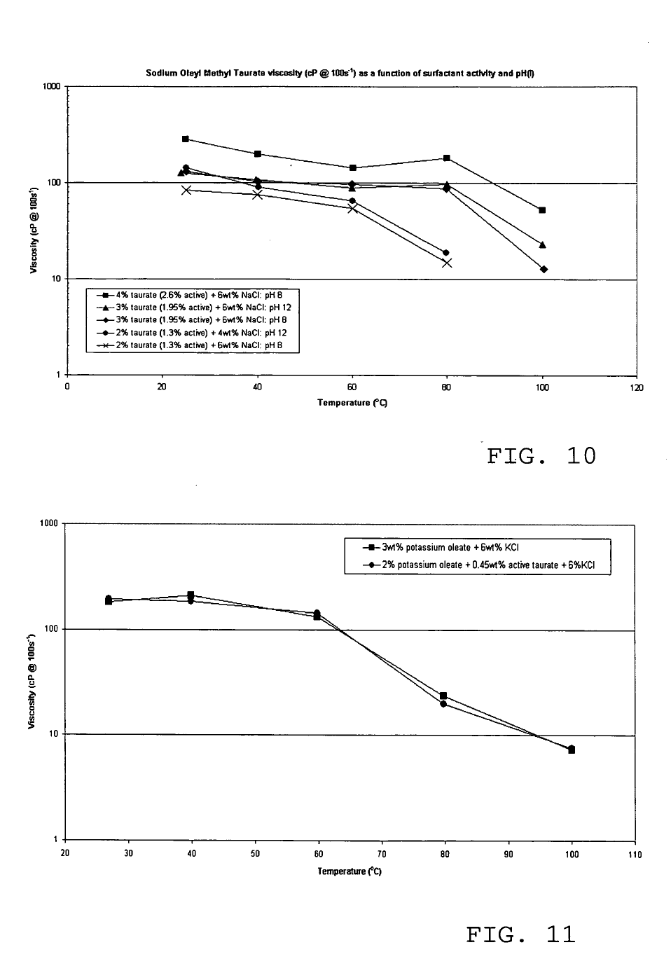

FIG. 9 shows that a stable foam is easily formed on vigorous shaking of a N-oleyl N-methyl taurate fluid at pH 3.5. This indicates that the foaming properties of the surfactant are maintained under low pH conditions such as those prevailing in a CO₂-foamed viscoelastic gel. By comparison this is not true for carboxylate surfactants of otherwise equivalent structure.

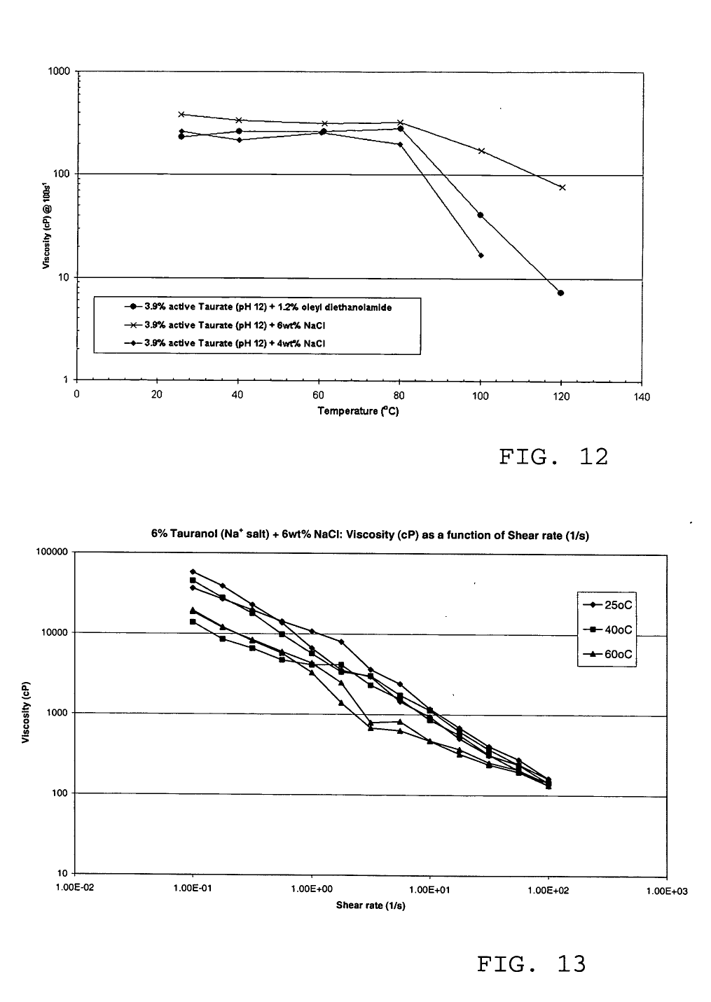

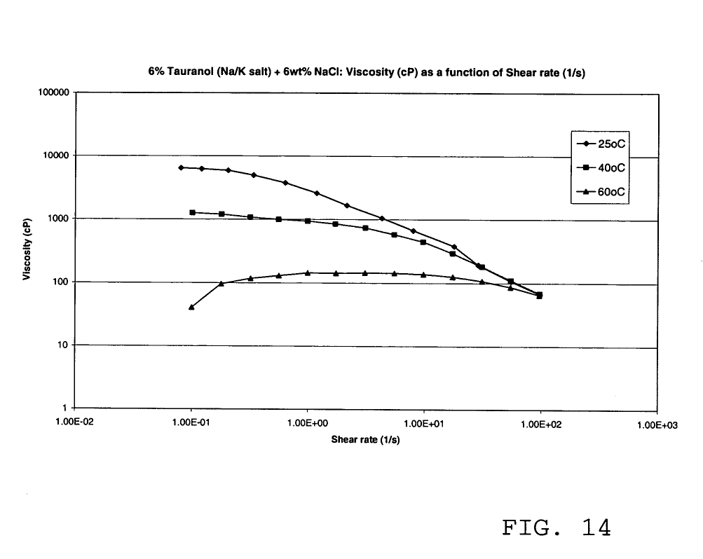

FIGS. 11 and 12 show the rheology of example formulations where the primary surfactant is N-oleyl N-methyl taurate in mixed surfactant systems containing a secondary surfactant. FIG. 11 shows that mixed N-oleyl N-methyl taurate/potassium oleate gels can be formulated for use under alkaline conditions. FIG. 12 shows that sodium N-oleyl N-methyl taurate can form a viscoelastic gel on addition of oleyl diethanolamide, in the absence of any added salt.

The performance of VES surfactant systems according to the present invention have been assessed in terms of the rheology.

A controlled stress rheometer (Bohlin model type CVO-50) was used to measure the Theological properties of the solutions. Using a concentric cylinders (Couette) geometry (inner radius of the outer cylinder, R_{i—=1.375} cm, outer radius of the inner cylinder, R_{o—=1.25} cm, and inner cylinder length=3.78 cm), corresponding to the geometry of German DIN standard 53019, the viscosity of each gel was measured at a particular shear rate.

For the particular geometry of the rheometer, the shear rate was calculated as:

$$\dot{γ} = \frac{RPM \cdot 2 π}{60} \frac{2 \cdot {R}_{i}^{2} {R}_{o}^{2}}{{( \frac{{R}_{i} + {R}_{o}}{2} )}^{2} ( {R}_{o}^{2} - {R}_{i}^{2} )} ,$$

where RPM is the rotational speed (in revolutions per minute) of the inner cylinder. The viscosity was then obtained for each measurement by dividing the measured stress by the calculated shear rate.

1. An anionic viscoelastic surfactant of formula I:
R—X—(CR₅R₆)ₘ—SO₃⁻
in which:
R is a saturated or unsaturated, linear or branched aliphatic hydrocarbon chain comprising from 6 to 22 carbon atoms, including mixtures thereof and/or optionally incorporating an aryl group;
X is —(C═O)N(R₇)—, —N(R₇)(C═O)—, —N(R₇)—, —(C═O)O—, —O(C═O)— or —O(CH₂CH₂O)ₚ— where p is 0 or an integer of from 1 to 5;
R₅ and R₆ are the same or different and are each independently hydrogen, a linear saturated aliphatic hydrocarbon chain of at least 1 carbon atom, a branched saturated aliphatic hydrocarbon chain of at least 2 carbon atoms, or a linear saturated aliphatic hydrocarbon chain of at least 1 carbon atom or a branched aliphatic hydrocarbon chain of at least 2 carbon atoms with one or more of the hydrogen atoms replaced by a hydroxyl group; or
when X is —N(R₇)(C═O)— or —O(C═O)—, the group (CR₅R₆) may include a COO⁻ group;
R₇ is a hydrogen, a linear saturated aliphatic hydrocarbon chain of at least 1 carbon atom, a branched saturated aliphatic hydrocarbon chain of at least 2 carbon atoms, a linear saturated aliphatic hydrocarbon chain of at least 1 carbon atom or a branched saturated aliphatic hydrocarbon chain of at least 2 carbon atoms with one or more of the hydrogen atoms replaced by a hydroxyl group, or a cyclic hydrocarbon group; and
m is an integer of from 1 to 4;
in the form of monomeric unit, a dimer or oligomer.

2. The surfactant of claim 1 wherein R is so selected as to have an iodine value (IV) within the range 1-200.

3. The surfactant of claim 2 wherein R is so selected as to have an iodine value (IV) within the range 40-110.

4. The surfactant of claim 1 wherein R is a fully or partially saturated, linear or branched hydrocarbon chain of at least 15 carbon atoms.

5. The surfactant of claim 1 wherein R is a fully or partially saturated, linear or branched hydrocarbon chain of 16 to 22 carbon atoms.

6. The surfactant of claim 1 wherein R is derived from palmitic acid, erucic acid, oleic acid, coconut oil acid, tallow acid, tall oil acid, soya oil acid or rapeseed oil acid.

7. The surfactant of claim 1 wherein R₅ and R₆ are the same.

8. The surfactant of claim 7 wherein R₅ and R6 are each hydrogen, a linear C₁₋₆ alkyl group or a branched C₂₋₆alkyl group.

9. The surfactant of claim 8 wherein R₅ and R₆ are each hydrogen or a methyl or ethyl group.

10. The surfactant of claim 1 wherein R₇ is hydrogen or a C₁₋₆ alkyl group or a C₁₋₆ alkyl group substituted with an aryl group.

11. The surfactant of claim 10 wherein R₇ is hydrogen, methyl, ethyl, propyl, butyl or a C:L₆alkyl group substituted with an aryl group.

12. The surfactant of claim 11 wherein R₇ is hydrogen or methyl.

13. The surfactant of claim 1 wherein m is 2 or 3.

14. The surfactant of claim 13 wherein m is 2.

15. The surfactant of claim 1, selected from the group consisting of:
R—CO—NR₇—(CR₅CR₆)ₘSO₃⁻ (Formula II);
R—N(R₇)(CO)—(CR₅R₆)ₘSO₃⁻ (Formula III);
R—N(R₇)—(CR₅R₆)ₘSO₃⁻ (Formula IV);
R—(C═O)O—(CR₅R₆)ₘSO₃⁻ (Formula V);
R—O(C═O)—(CR₅R₆)ₘSO₃⁻ (Formula VI); and
R—O(CH₂CH₂O)ₚ—(CR₅R₆)ₘSO₃⁻ (Formula VII)
with R, R₅, R₆, R₇, m and p defined in claim 1, as a monomeric unit,a dimer or oligomer.

16. The surfactant of claim 15 of formula IIA:
R—CO—NR₇—CH₂CH₂—SO₃⁻
wherein R and R₇ are as defined in claim 1, as a monomeric unit, dimer or oligomer.

17. The surfactant of claim 16 in which the group R—CO— is selected from N-palmityl, N-erucyl, N-oleoyl, N-cocoyl, N-tallowyl, N-tallyl, N-soyayl and N-rapeseedyl and R₇ is hydrogen or a C₁₋₆alkyl group.

18. The surfactant of claim 15 of formula IIIA:
R—N(R₇)(CO)—CH₂CH₂SO₃⁻
in which R and R₇ are as defined in claim 1, as a monomeric unit, dimer or oligomer.

19. The surfactant of claim 15 of formula VA:
R—(C═O)O—CH₂CH₂—SO₃⁻
wherein R is as defined in claim 1, as a monomeric unit, dimer or oligomer.

20. The surfactant of claim 15 of formula VIA:
R—O(C═O)—CH₂CH₂—SO₃⁻
wherein R is as defined in claim 1, as a monomeric unit, dimer or oligomer.

21. The surfactant of claim 15 wherein R is derived from palmitic acid, erucic acid, oleic acid, coconut oil acid, tallow acid, tall oil acid, soya oil acid or rapeseed oil acid.

22. The surfactant of claim 1 being an N-acyl N-methyl taurate.

23. The surfactant of claim 22 being N-cetyl N-methyl taurate, N-erucyl N-methyl taurate, N-oleoyl N-methyl taurate, N-cocoyl N-methyl taurate, N-tallowyl N-methyl taurate, N-tallyl N-methyl taurate, N-soyayl N-methyl taurate or N-rapeseedyl N-methyl taurate.

24. The surfactant of claim 1 being an N-acyl taurate.

25. The surfactant of claim 24 being N-cetyl taurate, N-erucyl taurate, N-oleoyl taurate, N-cocoyl taurate, N-tallowyl taurate, N-tallyl taurate, N-soyayl taurate or N-rapeseedyl taurate.

26. A viscoelastic gel treatment fluid comprising an anionic viscoelastic surfactant as defined in claim 1.

27. A wellbore treatment fluid comprising an anionic viscoelastic surfactant as defined in claim 1.

28. The wellbore treatment fluid of claim 27 being a fracturing fluid, selective acidising fluid, water shut-off fluid, well clean-out fluid or diversion fluid for acid and scale dissolver treatments.

29. A method for the preparation of a viscoelastic gel treatment fluid comprising admixing an anionic viscoelastic surfactant according to claim 1 with an alcohol or amine additive.
